(19) United States
(12) Patent Application Publication
(10) Pub. No.: US 2025/0170510 A1
(43) Pub. Date: May 29, 2025

(54) Particle Separator For Intake

(71) Applicant: Beihang University, Beijing (CN)

(72) Inventors: Jianhua ZHOU, Beijing (CN); Lei WANG, Beijing (CN)

(21) Appl. No.: 18/958,234

(22) Filed: Nov. 25, 2024

(30) Foreign Application Priority Data
Nov. 24, 2023 (CN) 202311585652.1

(51) Int. Cl. B01D 45/04

(52) U.S. Cl. CPC B01D 45/04

(57) ABSTRACT

Provided is a particle separator for an intake, relating to the technical field of aero engines. The particle separator for an intake includes a C-shaped intake, and a particle separation device. The intake is divided into an inlet segment (2), a bending segment (3), and an outlet segment (4). A direction of an airflow at the inlet segment (2) is reversely bent by 180° through the bending segment (3), and then the airflow enters the outlet segment (4); and the outlet segment (4) is externally connected. The particle separation device is arranged at the bending segment (3), and includes a separation flow path (7) outward in an air inlet direction. The airflow is controlled to be separated by controlling an inlet of the separation flow path (7), which makes most particles in the airflow discharged through the separation flow path (7) along with the airflow.

### CROSS-REFERENCE TO RELATED APPLICATION

This patent application claims the benefit and priority of Chinese Patent Application No. 202311585652.1, filed with the China National Intellectual Property Administration on Nov. 24, 2023, the disclosure of which is incorporated by reference herein in its entirety as part of the present application.

### TECHNICAL FIELD

The present disclosure relates to the technical field of aero engines, and in particular to a particle separator for an intake.

### BACKGROUND

When the helicopter takes off, lands and flies near the ground, various debris on the ground, such as sand dust, vegetation, ice and snow, will be sucked into the engine by airflow, making the working environment of the engine poor. The damage of sand dust to the engine is the most serious. If protective measures are not taken in advance, dust and sand will bring serious harm to the helicopters and engine: the wear of compressor blade, and resulted deterioration of engine performance, i.e., the decrease of power and the increase of fuel consumption rate, which eventually leads to the shortening of the service life of the engine.

For a small unmanned aerial vehicle (UAV), its application market will gradually expand in the future, so it is necessary to adapt to more complex and diverse takeoff conditions. While the UAV is used more widely, the demand for clean airport runway is higher. However, there are limited airport runways, it is necessary to reduce the dependence of UAV on the clean airport runway, thus making the UAV adapt to poor takeoff environment. Therefore, an air inlet protection device, i.e., a particle separator for an intake, is usually added in front of the engine to separate solid particles in the airflow containing impurities, thus protecting the engine, ensuring operation stability, and prolonging the service life of the engine.

Referring to that an existing inertial particle separator structure (referring to General Editorial Board of Aeroengine Design Manual. Aeroengine Design Manual: Inertial Particle Separator (IPS) mode of RTM322 engine on the intake and exhaust device in Volume 7), its flow channel is composed of an inner wall, an outer wall, a flow divider, and supporting plates or blades therein. The main feature of the flow channel is a curved bifurcated flow channel. The technical defects of the IPS are that due to the fixed geometry, the inertial particle separator can only compromise between multiple functions (air inlet and sand discharge) and different working conditions. Moreover, as the existing particle separator can still separate the flow rate in a cruising state, in order to ensure the flow rate of the engine, the flow rate at the inlet of the intake is increased, the flow rate in the intake is higher, making the total pressure loss greater. If the separation flow path needs to be closed when it is necessary, thus obtaining higher comprehensive performance. The main defect of IPS is that the actual action time is particularly limited, and only used in the take-off/landing and near-ground operation stages with bad air inlet conditions; but when the aircraft does not need the function of particle separation in the cruising state, the IPS will still bring power loss to the engine.

### SUMMARY

In order to overcome the technical problem above, an objective of the present disclosure is to provide a particle separator for an intake. The intake is a special C-shaped structure, and the particle separator is designed by using a large bending structure of the intake. The sand dust is thrown away from an airflow trajectory to a wall surface with its great inertia when the airflow turns sharply, and flows out of a separation flow path. Meanwhile, when the particle separator is not needed, the air pressure loss caused by the particle separator can be reduced. The present disclosure provides the following technical solutions:

A particle separator for an intake includes:
a C-shaped intake, which is divided into an inlet segment (2), a bending segment (3), and an outlet segment (4), where a direction of an airflow at the inlet segment (2) is reversely bent by 180° through the bending segment (3), then the airflow enters the outlet segment (4), and the outlet segment (4) is externally connected; and
a particle separation device, arranged at the bending segment (3) and comprising a separation flow path (7) outward in an air inlet direction, wherein the airflow is controlled to be separated by controlling an inlet of the separation flow path (7), which makes most particles in the airflow discharged through the separation flow path (7) along with the airflow.

According to some embodiments, the particle separation device includes an inner wall surface (31) of the bending segment, an outer wall surface (32) of the bending segment, and a rotating wall surface (33). The rotating wall surface is a part of outer wall surface of the bending segment (3). The separation flow path (7) is fixedly connected to the outer wall surface (32) of the bending segment and located on an outer side of the rotating wall surface (33). A rotating bearing (34) is arranged on an inner side of the separation flow path (7) and the outer wall surface (32) of the bending segment, and located on the outlet segment (4) side. A free end of the rotating wall surface (33) is towards an air inlet direction. The rotating wall surface (33) rotates with the rotating bearing (34) as a rotating shaft to control inlet area of the separation flow path (7). The airflow is segmented by the rotating wall surface (33), making most particles in the airflow flow into the separation flow path (7).

According to some embodiments, the cross-sectional area of the rotating wall surface (33) is 0.9-1.3 times area of an air outlet of the outlet segment (4).

According to some embodiments, the separation flow path (7) is externally connected to a sand discharging device.

According to some embodiments, the sand discharging device is a blower, or an ejector.

Compared with the prior art, the present disclosure has the following beneficial effects:

The particle separator for an intake provided by the present disclosure is simple in structure, and convenient for maintenance. The particle separation device is arranged at a bent part of the intake, which not only can achieve dust removal of the intake to improve inlet air mass, but also can close the separation flow path when the particle separator is not needed, thus reducing a total pressure loss and a flow distortion caused by the particle separator.

### BRIEF DESCRIPTION OF THE DRAWINGS

FIG. 1 is a schematic diagram of a particle separator for an intake according to Embodiment 1 of the present disclosure;

FIG. 2 is a diagram of the central cross section of a particle separator for an intake according to Embodiment 1 of the present disclosure;

FIG. 3 is a streamline diagram of the central cross section of a particle separator for an intake according to Embodiment 1 of the present disclosure;

FIG. 4 is a numerical simulation result of a motion trajectory of sand particles with a diameter of 200 μm in a flow channel of a particle separator for an intake according to Embodiment 1 of the present disclosure.

In the drawings:

1—air inlet; 2—inlet segment; 3—bending segment; 31—inner wall surface of bending segment; 32—outer wall surface of bending segment; 33—rotating wall surface; 4—outlet segment; 5—air outlet; 6—sand outlet; 7—separation flow path.

### DETAILED DESCRIPTION OF THE EMBODIMENTS

The present disclosure is described in detail below in conjunction with embodiments and accompanying drawings. However, it should be noted that the embodiments and accompanying drawings are only used to describe the present disclosure exemplary, rather than limiting the scope of protection of the present disclosure. All reasonable transformations and combinations included in the inventive concept of the present disclosure fall within the scope of protection of the present disclosure.

In the description of the present disclosure, it needs to be understood that the orientation or positional relationship indicated by terms “center”, “top”, “bottom”, “left”, “right”, “vertical”, “horizontal”, “inside” and “outside” is based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. The terms “first”, “second” and “third” are only used for descriptive purposes, and cannot be understood as indicating or implying relative importance. In addition, unless otherwise specified and limited, the terms “setting”, “mounting”, “connect” and “couple” should be broadly understood. For example, it may be fixed connection, detachable connection, or integrated connection; it may be mechanical connection, or electric connection; it may be direct connection, connection through an intermediate medium, or intercommunication of two elements. For those of ordinary skill in the art, the specific meanings of the above terms in the utility model can be understood on a case-by-case basis.

In the present disclosure, a C-shaped structure is combined, a bending segment is provided with a rotating wall surface, which acts like a flow divider. A large-angle bending structure formed by the inner wall surface and the outer wall surface of the bending segment acts like a curved flow channel formed by an inner wall and an outer wall. A flow channel in the intake forms a bifurcated flow channel under the action of the rotating wall surface, thus achieving the effect of particle separation. When there is no need of a particle separation function, the separation flow path is closed to reduce the loss of the engine and reduce the influence of the particle separator on a flow field of the intake, thus obtaining high comprehensive performance.

The present disclosure is further described below with reference to accompanying drawings.

### Embodiment 1

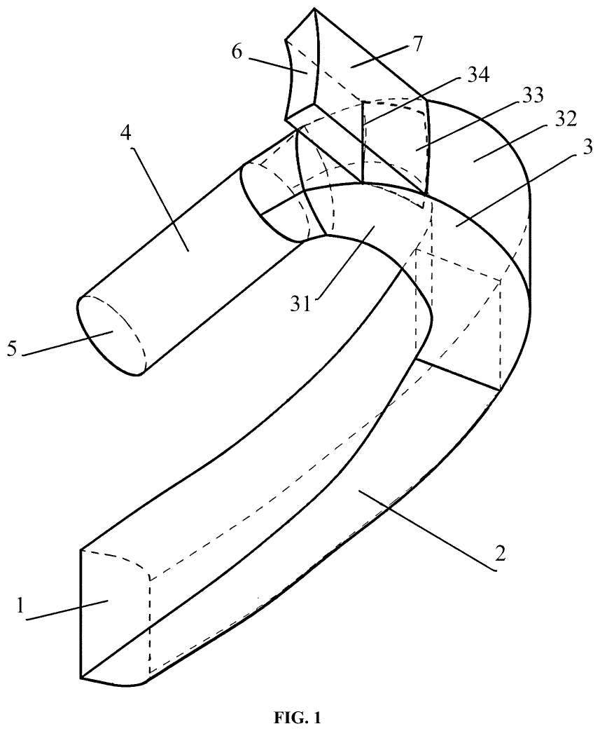

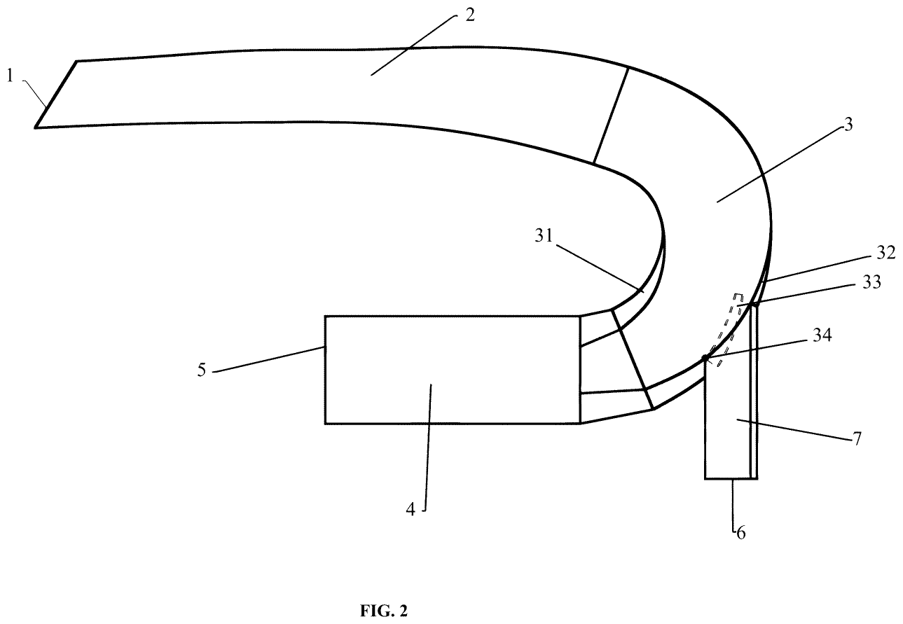

As shown in FIG. 1 to FIG. 2, a particle separator for an intake provided by this embodiment includes an intake, and a particle separation device. The intake is divided into an inlet segment 2, a bending segment 3, and an outlet segment 4 according to an air inlet direction. The entire intake is of a C-shaped 180-degree bending structure, with an air inlet 1 at an inlet of the inlet segment 2 and an air outlet 5 at an outlet of the outlet segment 4.

As shown in FIG. 2, the particle separation device includes an inner wall surface 31 of the bending segment, an outer wall surface 32 of the bending segment, and a rotating wall surface 33. The rotating wall surface 33 is a part of outer wall surface of the bending segment 3. The separation flow path 7 is fixedly connected to the outer wall surface 32 of the bending segment and located on an outer side of the rotating wall surface 33. A rotating bearing 34 is arranged on an inner side of the separation flow path 7 and the outer wall surface 32 of the bending segment, and located on the outlet segment 4 side. The rotating wall surface 33 is towards an air inlet direction, and rotates with the rotating bearing 34 as a rotating shaft to control inlet area of the separation flow path 7. The separation flow path 7 is externally connected to a sand discharging device, and a transition flow path needs to be designed according to the selected blower or ejector.

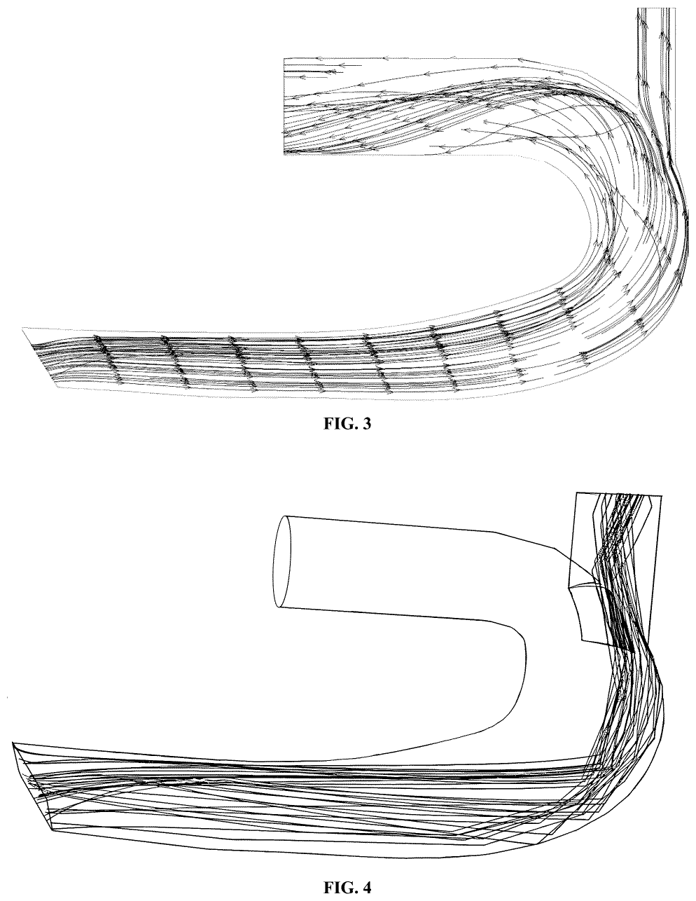

The rotating wall surface 33 is rotatably arranged on the outer wall surface 32 of the bending segment near a bend of a straight segment of the air outlet 5 through the rotating bearing 34, and an internal flow of the intake is segmented by the rotating wall surface 33. As shown in FIG. 3, the airflow is segmented by the rotating wall surface 33, and part of the airflow flows into the separation flow path 7.

Preferably, the cross-sectional area of the rotating wall surface 33 is 0.9-1.3 times the area of the air outlet 5. Excessively large area will lead to an increase in flow loss, while excessively small area will make the separation effect worse.

During operation, the air outlet 5 of the particle separator for an intake is connected to an engine compressor to provide flow rate for the engine, and the separation flow path 7 is externally connected to a sand discharging device (such as a blower, or an ejector), and a transition segment is connected designed according to the sand discharging device to be connected to the separation flow path 7.

The sand-containing airflow flows in from the air inlet 1 of the particle separator for an intake, and when the airflow passes through the bending segment 3 of the intake, the particles are separated under the influence of the rotating wall surface 33 and the inertial force, the clean airflow flows out from the air outlet 5, and the sand dust flows out from a sand outlet 6 through the separation flow path 7. In this embodiment, when the particle separator does not work, that is, when a rotation angle of the rotating wall surface 33 is 0-degree, the separation flow path 7 is closed, and the outer wall surface 32 of the intake returns to its original state, which has little influence on a flow field in the intake. Preferably, the rotating angle of the rotating wall surface 33 ranges from 10° to 15° during operation.

According to the particle separator for an intake provided by this embodiment, by adjusting and controlling the rotation of the rotating wall surface 33 and selecting the rotating angle according to the actual environment, the separation flow path 7 in a non-sand-dust environment can be closed, making most airflow enter the engine from the air outlet 5, and at this time, the performance of the intake is almost unaffected. When operating in the sand dust environment, the rotating wall surface 33 can be rotated with the rotation angle ranging from 10° to 15°. When a sand dust-containing airflow passes through the bending segment 3, the rotating wall surface 33 can divide the sand dust-containing airflow into two airflows, one sand dust-containing airflow (about 15% to 20% of the total air inflow) concentrated with a large amount of sand dust flows into the separation flow path 7 and is discharged to the atmosphere from the sand outlet 6, and another air flow containing almost no sand dust (about 80%-85% of the total air inflow) enters the engine.

A numerical simulation result indicates that in this embodiment, the separation efficiency for coarse sand (C sand) is greater than 95%, the separation efficiency for fine sand (AC sand) is greater than 85%, and the separation efficiency for particles with a diameter greater than 200 μm is higher than 99%.

When the rotating angle of the rotating wall surface 33 is 15°, a simulation result of the working condition at takeoff shows that a total pressure recovery coefficient is 0.9790, the separation efficiency for the coarse sand (C sand) is 95.13%, the separation efficiency for the fine sand (AC sand) is 85.16%, the separation efficiency for the particles with a diameter of 200 μm is 99.02%, and the separation efficiency for the particles with a diameter of 1000 μm is 99.97. FIG. 4 is a numerical simulation result of a motion trajectory of sand particles with a diameter of 200 μm in a flow channel of a particle separator for an intake. The rotating wall surfaces 33 rotates by 15°, and a line is a motion trajectory of particles.

The particle separator provided by this embodiment is of a variable structure. In terms of aerodynamic performance, in a cruising state at 5 km, the total pressure recovery coefficient of the existing non-variable particle separator is 0.9854, and the total pressure distortion intensity (DC60) is 0.13. Under the same working condition, in order to ensure the same outlet flow rate, the total pressure recovery coefficient of this embodiment is 0.9896, which is increased by about 0.43%, and DC60 is 0.09, which is decreased by about 30.76%. In a cruising sate at 8 km, the total pressure recovery coefficient of the non-variable particle separator is 0.9887, and the DC60 is 0.13. The total pressure recovery coefficient of this embodiment is 0.9915, which is increased by about 0.28%, and the DC60 is 0.11, which is decreased by about 15.38%.

The above is only the preferred embodiment of the present disclosure, and the scope of protection of the present disclosure is not limited to the above embodiments. All technical solutions under the idea of the present disclosure belong to the scope of protection of the present disclosure.

It should be noted that, for those of ordinary skill in the art, various modifications and embellishments can be made without departing from the principle of the present disclosure. Such modifications and embellishments shall be regarded as falling into the scope of protection of the present disclosure.

What is claimed is:

1. A particle separator for an intake, comprising
a C-shaped intake, which is divided into an inlet segment (2), a bending segment (3), and an outlet segment (4), wherein a direction of an airflow at the inlet segment (2) is reversely bent by 180° through the bending segment (3), then the airflow enters the outlet segment (4), and the outlet segment (4) is externally connected; and
a particle separation device, arranged at the bending segment (3) and comprising a separation flow path (7) outward in an air inlet direction, wherein the airflow is controlled to be separated by controlling an inlet of the separation flow path (7), which makes most particles in the airflow discharged through the separation flow path (7) along with the airflow.

2. The particle separator for an intake according to claim 1, wherein the particle separation device comprises an inner wall surface (31) of the bending segment, an outer wall surface (32) of the bending segment, and a rotating wall surface (33); the rotating wall surface is a part of outer wall surface of the bending segment (3); the separation flow path (7) is fixedly connected to the outer wall surface (32) of the bending segment and located on an outer side of the rotating wall surface (33); a rotating bearing (34) is arranged on an inner side of the separation flow path (7) and the outer wall surface (32) of the bending segment, and located on the outlet segment (4) side;
a free end of the rotating wall surface (33) is towards an air inlet direction; the rotating wall surface (33) rotates with the rotating bearing (34) as a rotating shaft to control inlet area of the separation flow path (7); and the airflow is segmented by the rotating wall surface (33), making most particles in the airflow flow into the separation flow path (7).

3. The particle separator for an intake according to claim 2, wherein cross-sectional area of the rotating wall surface (33) is 0.9-1.3 times area of an air outlet of the outlet segment (4).

4. The particle separator for an intake according to claim 2, wherein the separation flow path (7) is externally connected to a sand discharging device.

5. The particle separator for an intake according to claim 4, wherein the sand discharging device is a blower, or an ejector.
